(19) United States
(12) Patent Application Publication
(10) Pub. No.: US 2025/0225369 A1
(43) Pub. Date: Jul. 10, 2025

(54) COORDINATED DISTRIBUTION OF MACHINE LEARNING MODELS FOR SUSTAINABLE TRAINING ACROSS HETEROGENEOUS RESOURCE GROUPS

(71) Applicant: Cisco Technology, Inc., San Jose, CA (US)

(72) Inventors: Raghu Rajendra Arur, New Delhi (IN); Indermeet Singh Gandhi, San Jose, CA (US)

(21) Appl. No.: 18/409,258

(22) Filed: Jan. 10, 2024

(51) Int. Cl. G06N 3/045

(52) U.S. Cl. CPC G06N 3/045

(57) ABSTRACT

Methods are provided for coordinated distribution of machine learning models for sustainable training. The methods involve obtaining attributes of each machine learning model. The attributes include a training constraint and a computational requirement. The methods further involve obtaining power supply information about at least two computing resource groups. The power supply information relates to one or more power sources that supply power to the at least two computing resource groups. The methods further involve generating a deployment plan for training the machine learning models across the at least two computing resource groups based on the power supply information and the attributes. The deployment plan is configured to increase a use of the power from one or more renewable energy sources. The methods further involve distributing the machine learning models to the at least two computing resource groups for sustainable training of the machine learning models based on the deployment plan.

### TECHNICAL FIELD

The present disclosure generally relates to computer networks and systems.

### BACKGROUND

Sustainability and carbon footprint are factors that enterprises consider in operating their enterprises. Artificial intelligence and machine learning (AI/ML) models have become mainstream technologies in large enterprises for gaining enterprise insights to increase their top-line. These models are continuously trained using compute and power resources of enterprises. Training these models require significant power making them some of the most power-hungry jobs that many enterprises run. For example, graphic processing units (GPUs) may be used for training these models, which is energy consuming.

### BRIEF DESCRIPTION OF THE DRAWINGS

FIG. 1 is a diagram illustrating an environment in which model profiles are generated and stored in a model profiler storage, according to an example embodiment.

FIG. 2 is a diagram illustrating an environment in which a sustainability service obtains power supply information from an external source and asset inventory of computing resource groups, according to an example embodiment.

FIG. 3 is a diagram illustrating an environment in which a scheduler generates a deployment plan for training machine learning models across computing resource groups based on the power supply information and attributes of machine learning models stored in the model profiler storage, according to an example embodiment.

FIG. 4 is a diagram illustrating an environment in which one or more machine learning models are migrated to a different computer resource group based on the deployment plan, according to an example embodiment.

FIG. 5 is a flowchart illustrating a method of distributing machine learning models to computing resource groups for sustainable training based on the deployment plan, according to an example embodiment.

FIG. 6 is a hardware block diagram of a computing device that may perform functions associated with any combination of operations in connection with the techniques depicted and described in FIGS. 1-5, according to various example embodiments.

### DETAILED DESCRIPTION OF EXAMPLE EMBODIMENTS

### Overview

Techniques presented herein provide for coordinated distribution of machine learning models for sustainable training.

In one form, the methods involve obtaining attributes of each of a plurality of machine learning models. The attributes include a training constraint and a computational requirement. The methods further involve obtaining power supply information about at least two computing resource groups. The power supply information relates to one or more power sources that supply power to the at least two computing resource groups. The methods further involve generating a deployment plan for training the plurality of machine learning models across the at least two computing resource groups based on the power supply information and the attributes. The deployment plan is configured to increase a use of the power from one or more renewable energy sources. The methods further involve distributing the plurality of machine learning models to the at least two computing resource groups for sustainable training of the plurality of machine learning models based on the deployment plan.

### Example Embodiments

Artificial intelligence or machine learning (AI/ML) models are commonly deployed by enterprises to help with enterprise tasks and to gain various insights. AI/ML models include unsupervised machine learning, supervised machine learning, semi-supervised machine learning, and/or reinforcement machine learning. Some non-limiting examples of AI/ML models are deep neural networks, large language models (LLMs) such as recurrent neural networks, generative pre-trained transformers (GPT), bidirectional encoder representations from transformers (BERT), text-to-text transfer transformers (T5). For the sake of simplicity, AI/ML models are referred to as machine learning models or ML models throughout the disclosure. The machine learning models (ML models) include various other AI models and are not limited to the models noted above.

ML models are trained using specialized hardware such as graphic processing units (GPUs) and/or tensor processing units (TPUs). This results in high energy usage and carbon emissions. In other words, training ML models is a costly endeavor. It is computationally heavy and consumes a large amount of energy or power. For example, training a large LLM model may involve thousands of GPUs and take months. Moreover, faster training of the ML models uses more computing resources, which means using more power, and thus producing a larger carbon footprint i.e., higher carbon dioxide (CO2) emissions. Meanwhile, enterprises are trying to reduce their carbon footprint. Sustainability is a factor that enterprises consider in running their operations.

Many enterprises have distributed data centers around the world to provide geographic coverage and redundancy. These data centers may rely on different energy sources based on their location. Some may use mostly renewable energy sources such as solar or wind, while others rely more heavily on fossil fuels (non-renewable energy sources). While distributed training of ML models across data centers can improve sustainability by leveraging renewable energy, other factors are to be considered and are addressed by the techniques presented herein. That is, as enterprises deploy numerous ML models for various enterprise tasks, coordinating distribution of these ML models to various computing resource groups (e.g., data centers) becomes challenging, and there are factors to consider in distributing these ML models.

For example, a first factor to consider is varying compute, memory, and energy constraints that different ML models have for training. Larger deep learning models use more GPUs/TPUs to complete training within a specified time deadline. The techniques presented herein may account for various types of ML modes and their constraints in coordinating distribution (including migration) of these ML models to various computing resource groups.

A second factor to consider is heterogeneous hardware capabilities of various computing resource groups such as number of GPUs/TPUs available, memory, network capabilities, etc. There may also be differences in energy efficiency across hardware types i.e., power consumption may vary for different hardware types. The techniques presented herein may account for the heterogenous hardware capabilities and energy efficiencies of various computing resource groups (datacenters) in coordinating distribution (including migration) of these ML models.

A third factor to consider is different checkpointing characteristics of these ML models. In general, checkpointing involves stopping the training of a respective ML model, recording the state of the respective ML model e.g., neural network, and resuming where the training was left off. Checkpointing frequency and checkpointing techniques differ based on model's architecture (e.g., number of hidden layers and/or data parameter set). Some ML models perform full checkpointing while other ML models are configured to perform partial/incremental checkpointing. For example, in Parameter Efficient Fine Tuning (PEFT), which is gaining popularity (Low-Rank Adaptation of Large Language Models (LoRA) and Quantized LoRA (QLoRA)), only a small part of the additional neural network is fine-tuned instead of the whole ML model. As such, only the adapter neurons need to be checkpointed.

Moreover, enterprises have computing resource groups in different regions where the source of power supply is different at different times of the day. A first computing resource group may be powered by renewable energy source(s) in a first timeframe and a second computing resource group may be powered by the renewable energy source(s) in a second timeframe (that does not overlap with the first timeframe). As such, the ML models may be migrated, at a checkpoint, to the second computing resource group for the second timeframe. That is, the ML models may be migrated to different computing resource groups for sustainable training.

Using checkpointing and the fact that enterprises have computing resource groups in different regions where the source of power supply is different at different times of the day, the ML models may be migrated to different computing resource groups for sustainable training. The techniques presented herein may account for checkpointing characteristics and power supply forecasts in coordinating the distribution (including migration) of these ML models.

At least for the factors noted above, keeping sustainability as an optimization goal is difficult when the data center resources are heterogenous and ML models are different. The techniques presented herein provide a sustainable training service for different types of ML models and hardware resources based on model profiling and checkpoint management.

The techniques presented herein provide an orchestration service that coordinates distribution of ML models for training to various computing resource groups based on types of models being trained, type of GPU/TPU hardware resources, performance, cost, and/or energy sources. Specifically, the orchestration service (e.g., a scheduler) generates a deployment plan for coordinated distribution and migration based on model profiling, hardware resources, and energy sources. The techniques presented herein may reduce the carbon footprint (power consumption from non-renewable energy sources) in training ML models by intelligently distributing different ML models across various computing resource groups and migrating these ML models to different computing resource groups to continue training based on sustainability metrics. The techniques presented herein may further decrease training time and/or reduce costs in training ML models.

The techniques presented herein use model profiling, asset inventory, and time-series nature of energy or power sources that supply power to computing resource groups such as data centers that may be spread across geographies, to generate the deployment plan for training ML models including migrating these ML models to different resource groups based on available energy source and model profiling (checkpointing characteristics, specified training time deadlines, etc.).

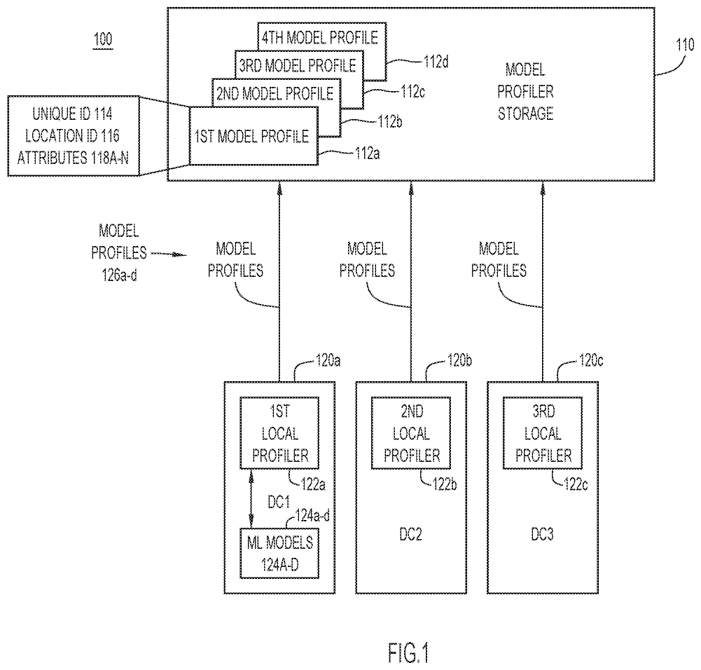

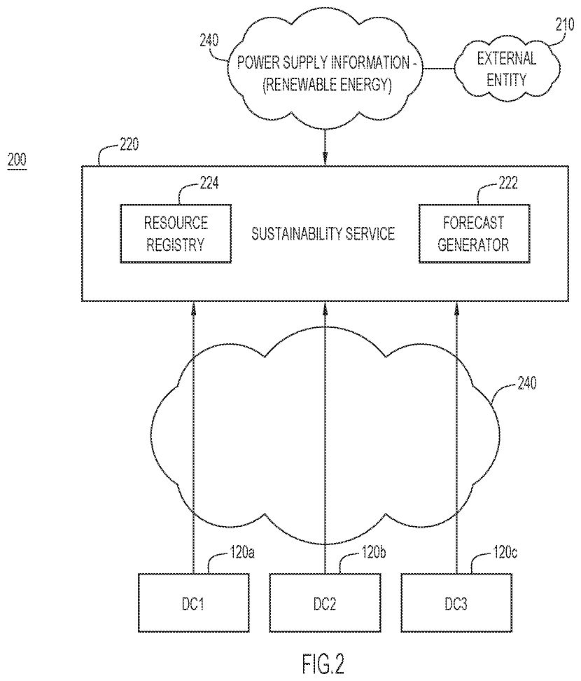

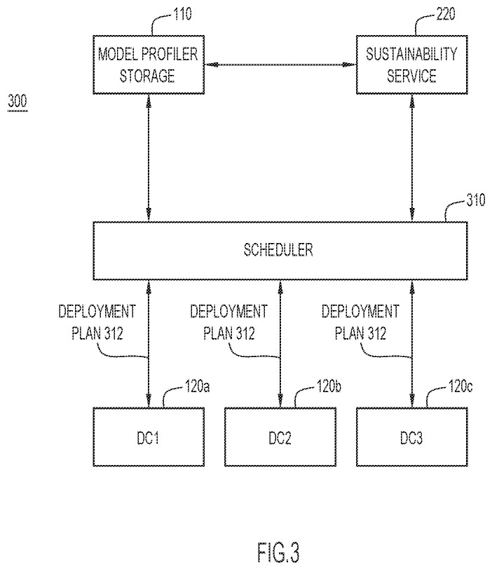

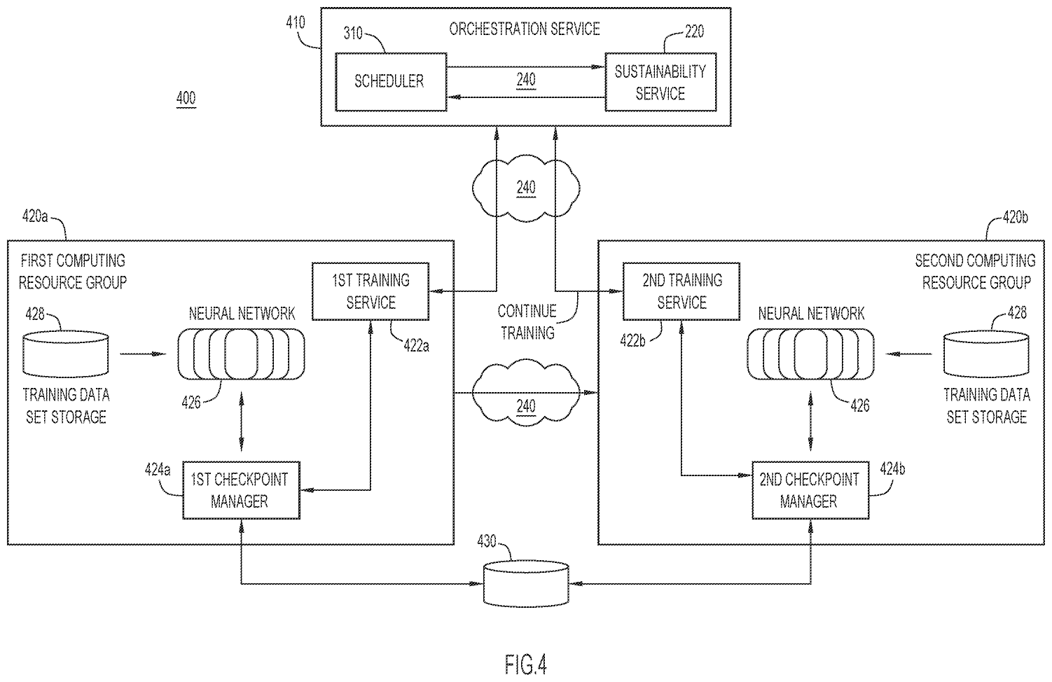

The techniques presented herein involve local model profilers that generate a profile for each ML model e.g., FIG. 1, a sustainability service that determines renewable energy forecasts and hardware capabilities (asset inventory) of computing resource groups, e.g., FIG. 2, a checkpoint manager that manages checkpointing capabilities of respective ML models for migrations and model interdependencies, and a scheduler that generates a deployment plan based on information from the model profilers, the sustainability service, and the checkpoint manager e.g., FIGS. 3 and 4.

FIG. 1 is a diagram of an environment 100 in which model profiles are generated and stored in a model profiler storage, according to an example embodiment. The environment 100 includes a model profiler storage 110 that stores model profiles 112a-d and datacenters 120a-c that include respective local profilers 122a-c.

The notations 1, 2, 3, . . . n; a, b, c, . . . n; “a-b”, “a-n”, “a-f”, “a-g”, “a-k”, “a-c”, and the like illustrate that the number of elements can vary depending on a particular implementation and is not limited to the number of elements being depicted or described. Moreover, these are only examples of various components, and the number and types of components, functions, etc. may vary based on a particular deployment and use case scenario. For example, the environment 100 may involve any number of computing resource groups at various geographically remote locations. The environment 100 may further involve one distributed data center with multiple enterprise sites and/or multiple data centers. The components in the environment 100 will vary based on a particular deployment and use case scenario.

The datacenters 120a-c are examples of computing resource groups. Specifically, the datacenters 120a-c include a first datacenter (DC1 120a) with a first local profiler 122a, a second datacenter (DC2 120b) with a second local profiler 122b, and a third datacenter (DC3 120c) with a third local profiler 122c.

A computing resource group includes hardware for training and/or deploying ML models such as graphics processing units (GPUs) and/or tenson processing units (TPUs). A computing resource group hosts network and computing equipment for training and/or deploying ML models e.g., servers in a data center. The network and computing equipment may further include a memory and a network communication interface that enables network communications. Types of the network and computing equipment may vary (e.g., memory size, network bandwidth, number of GPUs/TPUs, etc.) depending on a particular deployment and use case scenario

In one example embodiment, computing resource groups are geographically remote enterprise sites of a distributed data center. Each geographically remote enterprise site includes GPUs and/or TPUs. In another example embodiment, computing resource groups are different data centers that host network and computing equipment for performing hosting and computing functions such as training and/or deploying ML models. In yet another example embodiment, computing resource groups may be a set of specialized hardware that are in the same location but powered by different energy sources. These are only examples of computing resource groups, and the number and types of components, functions, etc. of computing resource groups may vary based on a particular deployment and use case scenario. For example, computing resource groups may belong to different enterprises e.g., two different service providers.

Each computing resource group includes a local profiler (e.g., the first local profiler 122a, the second local profiler 122b, and the third local profiler 122c). The local profiler executes an automated benchmarking suite on each ML model to determine various attributes of this ML model. The local profiler then generates a model profile for each ML model in the computing resource group.

For example, the DC1 120a may store ML models 124a-d. Before starting the training of the ML models 124a-d, the first local profiler 122a generates model profiles 126a-d (a profile for each model such as a first model profile 112a, a second model profile 112b, a third model profile 112c, and a fourth model profile 112d). That is, the first local profiler 122a extracts attributes of a respective ML model such as an architecture of the respective ML model (characteristics of the input layer and the output layer, number of hidden/intermediate layers, parameter data set for training, number of iterations for training, etc.)

The attributes may further include training constraints such as checkpointing characteristics (frequency and type of checkpointing e.g., is incremental checkpoint supported). For example, checkpointing may occur after a predetermined number of iterations in training the ML model. Checkpointing characteristics include supported checkpoint formats and/or checkpoint parameters (size of the result data set). For example, the checkpointing characteristics may specify types of checkpointing formats compatible with the ML model framework such as TensorFlow, PyTorch, or Keras. Additionally, the checkpointing characteristics may involve whether incremental or partial checkpointing is supported, and/or frequency of checkpointing (after how many iterations, incremental checkpointing is to occur). Checkpointing characteristics may help determine how checkpoints may be saved (the result data set and its size) and transported (migrated to a different resource group) and the network bandwidth to be used for the migration.

The training constraints may further include training dataset size, an expected training time (e.g., a specified time deadline). Training dataset size is a value indicating the size of the full dataset for training the ML model and the size of the result data set (after checkpointing). Larger datasets like ImageNet require substantial storage capacity (memory size) at each data center location to distribute training batches. Expected training time is an estimate of the time required to fully train the model for a given number of epochs (iterations) based on its complexity. Simpler ML models train faster than larger ML models.

Attributes of the respective ML model may further include computational requirements (hardware resource requirement) to train the respective ML model within a predetermined timeframe such as the number of GPUs/TPUs, memory constraint (memory size), and/or network constraints (network bandwidth). For example, these computational requirements may include a minimum number of GPUs/TPUs to train the respect ML model based on its complexity. Larger and more complex ML models like transformers use more hardware resources to train in a predetermined or specified timeframe e.g., by a predetermined time deadline. In one example embodiment, the first local profiler 122a may run tests to determine the hardware resources to achieve a targeted training iteration rate.

The memory constraints include memory and storage for training the respective ML model. For example, the GPU memory size for storing the model parameters, activations, and training dataset batches during the forward and backward pass. Also, the storage capacity for storing the full training dataset. Memory usage may be a constraint for large deep learning models.

The network constraints include the network bandwidth for efficiently distributing the training batches to the allocated hardware resources. Insufficient network capacity between GPUs causes delays that slow down training. The network constraints may further include the network bandwidth needed for migrating the ML models to a different datacenter.

Further, the attributes may include a power consumption profile. For example, the first local profiler 122a may run the ML model on sample hardware to generate power usage over time (power consumption information). Based on the power usage over time by the respect ML model, the first local profiler 122a generates a power consumption profile for the respective ML model. The power consumption of GPUs/TPUs varies based on the ML model's architecture and batch size. This fine-grained power consumption profile is used to estimate overall power to train the respective ML model.

The first local profiler 122a generate a model profile based on the extracted attributes (ML model information). For example, the first local profiler 122a generates the model profiles 126a-d for the ML models 124a-d and transmits them to the model profiler storage 110. Each local profiler (the first local profiler 122a, the second local profiler 122b, and the third local profiler 122c) generates model profiles for ML models at their respective datacenters (the DC1 120a, the DC2 120b, and the DC3 120c), which are then pushed or provided to the model profiler storage 110.

The model profiler storage 110 is a unified storage repository that stores ML model profiles of ML models at the datacenters 120a-c. Each model profile includes attributes of the respective ML model generated by the respective local profiler. For example, the first model profile 112a for a first ML model. The first model profile 112a includes a unique identifier (a unique ID 114) assigned to the first ML model, a location identifier (a location ID 116) that identifies the DC1 120a, and attributes 118a-n.

The attributes 118a-n may include training constraints (e.g., checkpointing characteristics such as frequency and type of checkpointing, time constraints such as a specified deadline or a timeframe, number of iterations, etc.). The attributes 118a-n may further include computational requirements (e.g., hardware resource requirements for training the first ML model within the specified timeframe, the memory size for storing parameters for training the first ML model within the specified timeframe, the network bandwidth for distributing training batches of the first ML model to the hardware resources and/or for migrating the first ML model). The attributes 118a-n may further include the power consumption profile for training the first ML model.

When a user submits a new ML model for training, the model profiler at the respective computing resource group extracts attributes of the new ML model (the architecture, resource requirements, and training characteristics), generates a model profile, and provides the model profile to the model profiler storage 110. As such, before training the ML model (e.g., the new ML model), the model profile is cataloged in the model profiler storage 110 e.g., a model registry database. The model profile is assigned a new unique ID for the new ML model, the location ID for the respective computing resource group, and associated metadata (attributes).

The model profiler storage 110 communicates with other components such as the sustainability service and the scheduler to provide details about the registered ML models. The details include architecture parameters (e.g., layers and connectivity to enable partial/incremental checkpointing). Further, the model profiler storage 110 updates the model profiles based on instructions from the scheduler e.g., when the ML models are migrated to different computing resource groups, the location ID is updated to reflect the new computing resource group for the unique ID of the respective ML model.

With continued reference to FIG. 1, FIG. 2 is a diagram illustrating an environment 200 in which a sustainability service 220 obtains power supply information from an external source and asset inventory of computing resource groups, according to an example embodiment. The environment 200 includes the DC1 120a, the DC2 120b, and the DC3 120c of FIG. 1 (examples of computing resource groups), an external entity 210, the sustainability service 220, and network(s) 240.

The external entity 210, the sustainability service 220, and the computing resource groups may be remote entities that communicate with one another via the network(s) 240. The network(s) 240 include one or more networks such as, but not limited to, local area network (LAN), wide area network (WAN) (e.g., the Internet). The network(s) 240 is a network infrastructure that enables connectivity and communication between entities in the environment 200.

The external entity 210 stores power supply information (such as a first power supply information for the DC1 120a, a second power supply information for the DC2 120b, and a third power supply information for the DC3 120c) about power sources for various geographic areas (such as a location A of the DC1 120a, a location B of the DC2 120b, and a location C of the DC3 120c).

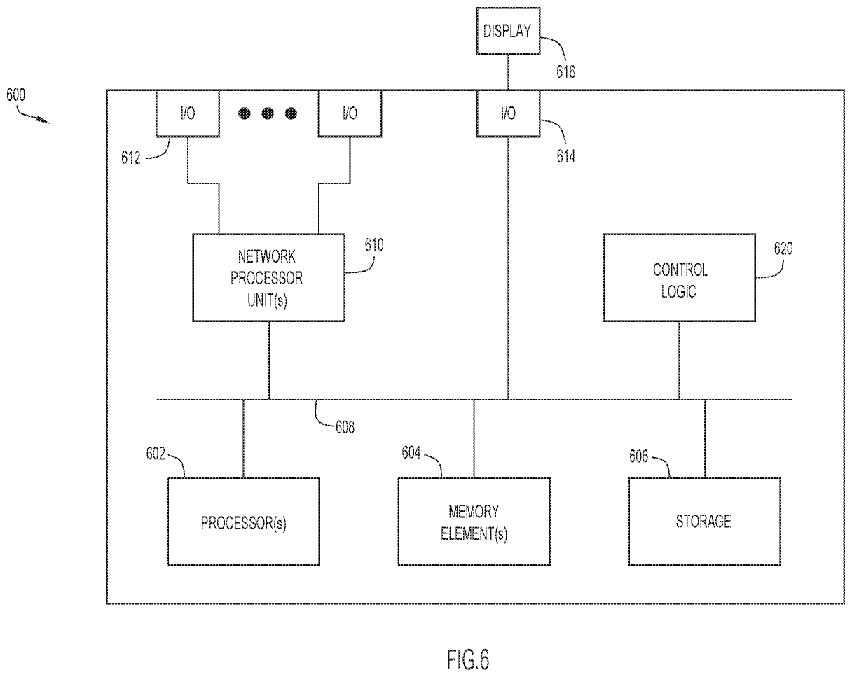

The external entity 210 may be an external energy broker that includes one or more computing devices of FIG. 6 and databases that store historical data trends of power sources that supply power and/or data about power sources that currently power the computing resource group. For example, the external entity 210 provides percentages or amounts of power from multiple power sources with a minute-by-minute granularity using an API. The external entity 210 may be a service (e.g., electricity map services) in which users input power supply information i.e., time-series energy supply, for each of computing resource group. The external entity 210 may be a third party energy information provider, etc. but is not limited thereto. The power supply information may also be input by a user.

The power supply information may be in a form of amount of energy supplied e.g., megawatts (MW) at various times e.g., one minute, five minutes, one hour intervals, etc. but is not limited thereto. In one example embodiment, the energy breakdown may be by percentages and/or at a particular point in time. In yet another example embodiment, the power supply information may indicate a first portion of the power supplied by the one or more renewable energy sources and a second portion of the power supplied by one or more non-renewable energy sources of a total power supplied to the respective computing resource group at a particular point in time.

In general, power supplied to a computing resource group such as a datacenter or an enterprise site (a particular location), is a mixture of energy or power from various power sources (a first portion from renewable energy sources and a second portion from non-renewable energy sources). That is, power supply sources include renewable power sources and non-renewable energy or power sources. Non-renewable power sources may be natural gas, large hydro, imported power, battery, nuclear power, coal, etc. The renewable energy sources may be solar, wind, geothermal, biomass, biogas, small hydro, etc. Combination of these various power sources that supply power to a computing resource group may vary over time within a day and over days within a year, for example. For example, in California (e.g., at a location A), the day's supply of power is mostly from renewable energy sources (the first portion is greater than the second portion) and during the night, non-renewable power sources are mostly used to power the region (the second portion is greater than the first potion).

In one or more example embodiments, the granularity of the power supply information varies depending on the external entity used and use case scenario. For example, the power supply information may indicate that at 7:15 am (point in time), at a target location, renewable energy sources supplies 13,035 MW, natural gas energy sources (non-renewable) supplies 4,038 MW, large hydro energy sources (non-renewable) supplies 3,115 MW, and nuclear energy sources (non-renewable) supplies 2,264 MW, etc. Additionally, the power supply information may indicate power supplied from various renewable energy sources e.g., 5,520 MW is supplied by a solar energy source, 3,612 MW is supplied by a wind energy source, etc. In one example embodiment, the power supply information may indicate percentage of power from renewable energy sources versus non-renewable power sources by months, weeks, days, hours, minutes, etc.

In one example embodiment, multiple energy brokers may be used to obtain the power supply information. External entities typically provide application programming interfaces (APIs) to query the combination of power sources and/or percentages at any given point in time of the day and/or month. The sustainability service 220 performs one or more API calls to the external entity 210 (one or more energy brokers) to obtain data about a portion of a total power supplied by each of a plurality of power supply sources that power a respective computing resource group (e.g., a target location or a target computing resource group).

Apart from getting power supply data from the external entity 210, a user may input the energy source supply as a time-series if they have the information or input information about the external entity that can provide a time-series view of the combination of energy sources at each geographical location of a distributed data center at a particular point in time.

The external entity 210 provides the power supply information for each computing resource group (e.g., each of enterprise data centers and/or locations of the distributed data center) to the sustainability service 220.

The sustainability service 220 may be implemented on one or more computing devices of FIG. 6 configured to process data, host applications, and communicate with other entities in the environment 200 using the network(s) 240. The sustainability service 220 may be in a form of a software product that resides in an enterprise network and/or in one or more cloud(s). The sustainability service 220 is implemented network and computing equipment. The sustainability service 220 communicates with the external entity 210 using API calls, for example, to obtain power supply information.

The sustainability service 220 includes a forecast generator 222 and a resource registry 224. In one example embodiment, the sustainability service 220 may exclude the forecast generator 222 or the forecast generator 222 may be a separate entity that communicates with the sustainability service 220.

The forecast generator 222 continuously monitors and forecasts renewable energy availability across all the distributed data centers (e.g., the DC1 120a, the DC2 120b, and the DC3 120c). The forecast generator 222 aggregates real-time renewable energy levels from renewable energy sources such as on-site solar panels and co-located wind farms. Historical generation data is used to generate time series models that can predict future renewable energy availability at each data center based on weather forecasts, seasonality, and other factors.

For example, power sources that supply power to a particular geographical location e.g., a computing resource group, may be seasonal but this is just an example. When the data is seasonal, the forecast generator 222 baselines the data and predicts power use for hours and/or days in the future. In one example embodiment, the forecast generator 222 uses Fast Fourier Transform (FFT) and fb-prophet to generate baselining (specific to a computing resource group) that predicts the combination of energy sources at a given point in time and at a given day. Both FFT and fb-prophet are efficient algorithms, which take negligible time to train and predict. The baselines may be in a form of percentage of renewable energy plotted against time. The renewable energy may be plotted in 5 minutes time intervals, in hour intervals, etc.

By generating the baselines, computational cost of determining the target location/the target computing resource group for training ML models is reduced. If forecasting is not performed (the forecast generator 222 is not used), then the external entity 210 is queried every time a determination is to be made, using API calls. However, each API call is an additional computational cost and frequent API calls to the external entity 210 may increase the computational cost.

In one example embodiment, the forecast generator 222 may analyze power supply information related to at least two computing resource groups to determine whether to invoke the forecast generator 222. If a pattern cannot be detected, the sustainability service 220 uses API calls when needed. If a pattern is detected, the forecast generator 222 is invoked to generate the baselines.

Using the power supply information for at least two computing resource groups (e.g., various locations of a distributed data center such as DC1 120a, DC2 120b, and DC3 120c), the sustainability service 220 determines sustainability metrics to use by a scheduler in coordinating distribution of ML models i.e., generating a deployment plan. The deployment plan may include migrations of ML models to continue training at a different computing resource groups e.g., when an amount of total renewable energy falls below a predetermined threshold or when it is lower than total renewable power available at the different computing resource groups. In other words, the deployment plan includes instructions for migrating ML models to a different computing resource group based on the time-series energy baseline of a current computing resource group indicating that the first portion is below a predetermined threshold or less that what is available at a target computing resource group.

The sustainability service 220 further maintains a resource registry 224. The resource registry 224 is a data store, a database, or a data center registry that catalogs the locations of the DC1 120a, the DC2 120b, and DC3 120c, hardware capabilities, energy costs, and renewable energy forecasts for each registered datacenter. Locations with cheaper energy costs and higher renewable energy availability are prioritized by the scheduler in generating the deployment plan. The entries in the resource registry 224 are updated as new data centers are added, forecasts change (e.g., renewable energy sources are above a predetermined threshold (50%)), or computing resource groups are updated/reconfigured (e.g., new GPU become available decreasing total training time of the ML models).

Each computing resource group such as the DC1 120a, the DC2 120b, and the DC3 120c communicate with the sustainability service 220 via the network(s) 240. Specifically, each computing resource group provides its geographic location (for obtaining power supply information) and hardware resources information. The hardware resources information includes asset inventory of the respective computing resource group i.e., assets available for training ML models. The asset inventory includes resources available for training ML models such as computing resources, memory resources, and connectivity (network resources). For example, the asset inventory may include the number of GPUs, the number of TPUs, the number of CPUs that are available for training ML models, available storage for training ML models, and network bandwidth.

When a new ML model training job is submitted to a target computing resource group, the sustainability service 220 runs the scheduler to analyze the current renewable energy forecasts and find the optimal computing resource group for training the new ML model based on maximizing the use of renewable energy sources, and thus, decreasing the cost of training the model. The sustainability service 220 may periodically rerun the scheduler during active training jobs to account for changing renewable energy availability (above/below a predetermined threshold) and configuration changes of the computing resource groups. The ML models (including the new ML model) may be dynamically migrated to different data centers by accounting for these changes (e.g., power from renewable energy sources falls below a predetermined threshold). The deployment plan is regenerated based on detected changes in power supply, asset inventory, and/or ML models.

When generating a new deployment plan to include the new ML model, the scheduler determines a checkpointing type of the new ML model, obtains weighted objectives for the deployment plan (e.g., decreasing costs of training, decreasing carbon footprint, decreasing training time, etc.), and determines a target computing resource group to train each ML model in an interval between two adjacent checkpoints specific to a respective ML model. The scheduler may generate the new deployment plan by applying a multi-objective genetic algorithm. The new deployment plan may include migrations of the ML models to different computing resource groups to meet the weighted objectives (train in intervals between adjacent checkpoints).

With continued reference to FIGS. 1 and 2, FIG. 3 is a diagram illustrating an environment 300 in which a scheduler 310 generates a deployment plan for training machine learning models across computing resource groups based on the power supply information and attributes of machine learning models stored in the model profiler storage, according to an example embodiment. The environment 300 includes the model profiler storage 110 of FIG. 1, the sustainability service 220 of FIG. 2, a scheduler 310, and the datacenters 120a-c of FIGS. 1 and 2.

The scheduler 310 may be implemented on one or more computing devices of FIG. 6 configured to process data, host applications, and communicate with other entities in the environment 300 using the network(s) 240 of FIG. 2. The scheduler 310 may be in a form of a software product that resides in an enterprise network and/or in one or more cloud(s). The scheduler 310 is implemented network and computing equipment. The scheduler 310 communicates with the model profiler storage 110 and the sustainability service 220 using API calls, for example, via the network(s) 240 of FIG. 2.

The scheduler 310 obtains attributes of the ML models from the model profiler storage 110 e.g., the model profiles 112a-d. Attributes may include the unique identifier, location information, and training constraints and computational requirements for the ML models to be trained.

The scheduler 310 further obtains power supply information about at least two computing resource groups e.g., the DC1 120a, the DC2 120b, and the DC3 120c. The power supply information relates to one or more power sources that supply power to the computing resource groups such as available power for training ML models from renewable energy sources and available power from other sources. The scheduler 310 may obtain the power supply information from the sustainability service 220 e.g., from the forecast generator 222 when the power supply information is in a form of baseline predictions. In one example embodiment, the scheduler 310 may directly communicate with an external entity to obtain power supply information.

The scheduler 310 further obtains inventory of available hardware resources from the sustainability service 220 e.g., asset inventory stored in the resource registry 224 is provided to the scheduler 310. In one example embodiment, the scheduler 310 may directly communicate with the DC1 120a, the DC2 120b, and the DC3 120c to obtain asset inventory.

The scheduler 310 generates a deployment plan 312 for training the ML models at various computing resource groups based on the power supply information, available hardware resources at the DC1 120a, the DC2 120b, and the DC3 120c and attributes of the ML (model profiles 112a-d). Specifically, the scheduler 310 applies a multi-objective genetic algorithm that considers various distributions of ML models across computing resource groups to generate the deployment plan 312. The scheduler 310 computes, determines, and/or generates the deployment plan 312 for training multiple ML models (using the multi-objective genetic algorithm) and deploy these ML models to various computing resource groups with the help of the sustainability service 220 and training services at each of the computing resource groups.

The deployment plan 312 is updated periodically and/or based on triggering events. For example, the deployment plan 312 may be updated when a new ML model is added to the model profiler storage 110 (e.g., first triggering event). That is, changes in the model profiles 112a-c stored in the model profiler storage 110 may trigger the scheduler 310 to generate a new deployment plan by applying the multi-objective genetic algorithm.

Changes in the resource registry 224 may also trigger the scheduler 310 to update the deployment plan 312 (e.g., second triggering event). That is, when changes in the asset inventory of the computing resource groups are detected, the scheduler 310 may generate a new deployment plan by applying the multi-objective genetic algorithm.

Specifically, the scheduler 310 applies a core algorithm that determines placement of training jobs (ML models training). For each ML model, the scheduler 310 determines model's training constraints and computational requirements (from the model profiler storage 110) and finds compatible data centers from the resource registry 224 that can meet the ML model's constraints based on their hardware capacity and availability. The scheduler 310 then evaluates all possible allocation combinations and scores them against multiple optimization objectives to generate a deployment plan that best meets the objectives.

For example, objectives may include maximizing cumulative renewable energy usage across all ML models being trained. That is, if a computing resource group is switched to being powered by a non-renewable energy source(s), the scheduler 310 generates instructions in the deployment plan to migrate the ML to a different computing resource group. The objectives may include minimizing total training time by selecting data centers with required hardware being available, minimizing energy costs based on variable data center energy prices, and/or meeting ML model performance constraints or training time deadlines. In one example embodiment, the objectives may be assigned various weights based on their importance. For example, a first objective of meeting ML model performance constraints may be assigned the highest weight (as the most important objective), a second objective of maximizing cumulative renewable energy usage may be assigned a medium weight (as an important objective), and other objectives may be assigned low weight (as less important objectives).

To evaluate various possible combinations, the scheduler 310 uses the renewable energy forecasts from the sustainability service 220 to calculate aggregate renewable energy percentage overtime. The scheduler 310 further estimates training times based on model requirements, hardware mapping, and data center capabilities. In one example embodiment, energy costs may be obtained directly from the data center registry (i.e., the resource registry 224).

In one example embodiment, the scheduler 310 uses a multi-objective genetic algorithm such as non-dominated sorting genetic algorithm (NSGA-II) to evaluate all possible data center combinations and find optimal placements for ML models that maximize renewable energy usage while meeting training constraints. The algorithm evolves generations of model-to-datacenter assignment solutions toward the Pareto frontier trading off sustainability and performance. The top placement combination is selected from the converged final generation and used to deploy the models to the assigned data centers via the training service.

The scheduler 310 reruns the algorithm at periodic intervals to account for changing conditions across the data centers. It also re-evaluates placements when new models are submitted to avoid resource fragmentation. Interdependent models are co-located by constraining their placement combinations. In one example embodiment, the scheduler 310 determines whether one or more ML models need to be migrated to a different resource group (datacenter) at checkpointing. The scheduler 310 communicates with one or more training services of various datacenters to continue training the models and/or to migrate the ML models based on the updated deployment plan. In one example embodiment, the scheduler 310 communicates the deployment plan 312 and/or updated deployment plans to the sustainability service 220, which then communicates with the training services at the respective datacenters 120a-c to distribute the ML models for sustainable training at various data centers.

FIG. 4 is a diagram illustrating an environment 400 in which one or more machine learning models are migrated to a different computer resource group based on the deployment plan, according to an example embodiment. The environment 400 includes an orchestration service 410, computing resource groups 420a-b such as a first computing resource group 420a and a second computing resource group 420b, and a shared persistent checkpoint storage system 430.

The orchestration service 410 includes the sustainability service 220 of FIGS. 2 and 3 and the scheduler 310 of FIG. 3. The sustainability service 220 and scheduler 310 may act in cooperation with one another to distribute and migrate various ML models to computing resource groups 420a-b. The orchestration service 410 is configured to implement the deployment plan by instructing the computing resource groups 420a-b to perform ML training jobs including migrating ML models at checkpointing to meet the deployment plan objectives i.e., to reduce the carbon footprint, costs, and/or training time.

In one example embodiment, the deployment plan includes instructions for a target location for training of a respective ML model at an interval between two adjacent checkpoints. For example, the deployment plan may indicate that three ML models are to be trained at the first computing resource group 420a before the first checkpoint when power from the renewable energy sources exceeds a predetermined threshold at the first computing resource group 420a. Two ML models (e.g., codependent models) are then to be migrated (transferred) to the second computing resource group 420b for continued training at the second computing resource group 420b. The third ML model is to be transferred at a second checkpoint to another computing resource group (not shown). The instructions from the deployment plan are distributed to the training services that migrate the ML models with the help of associated checkpoint managers.

Specifically, each computing resource group includes a training service and a checkpoint manager. For example, the first computing resource group 420a includes a first training service 422a and a first checkpoint manager 424a and the second computing resource group 420b includes a second training service 422b and the second checkpoint manager 424b.

Each training service runs at a respective computing resource group and handles active ML model training jobs assigned to its computing resource group, by the orchestration service 410. For example, the first computing resource group 420a is training a neural network 426 using parameters from a training data set storage 428.

The training service pulls a list of ML models to train (from the orchestration service 410) and handles dataset replication, hardware allocation, and launching training containers. The training service is further configured to monitor all ML model training jobs and track their iteration progress. The training service integrates with the checkpoint manager to orchestrate periodic checkpoints during training (after a predetermined number of iterations). Performance metrics like accuracy and loss are pushed back to the orchestration service 410 (i.e., the sustainability service 220) to monitor training progress.

In one example embodiment, when notified (e.g., instructions in the deployment plan), the training service pauses an ML model training job, checkpoints it, and transfer the ML model training job to the newly assigned computing resource group (migration of ML model). This enables smooth migration of the ML model as renewable energy availability changes. For example, the neural network 426 is transferred to the second computing resource group 420b, at a checkpoint, for continued training.

Each checkpoint manager determines optimal checkpointing approaches for each ML model based on their architecture using details from the model registry i.e., the model profile. For models like RNNs that support incremental checkpointing, the checkpoint manager checkpoints only the model weights or activations that changed since the last save. This minimizes checkpoint size and transfer overhead. In one example embodiment, the checkpoints are versioned and saved to a shared persistent checkpoint storage system 430 that is accessible to the training services 422a-b (across all registered computing resource groups 420a-b). Metadata is stored with each checkpoint detailing model topology, hardware bindings, batch size, etc. to simplify restoration on different hardware (i.e., migration to the target computing resource group).

For example, when the orchestration service 410 instructs to migrate the neural network 426 (that uses training data set stored the a training data set storage 428) to the second computing resource group 420b, the second checkpoint manager 424b loads the latest incremental checkpoint from the shared persistent checkpoint storage system 430 so training can resume from the last point rather than restarting. The neural network 426 is moved to the second computing resource group 420b (parameters are stored in the training data set storage 428 of the second computing resource group 420b).

By tuning checkpoint frequency, storage, and restores based on model architecture, the orchestration service 410 minimizes transfer time and disruption when migrating ML models between computing resource groups for improved sustainability. The orchestration service 410 generates different instructions for different models in the deployment plan. For example, while the neural network 426 may be migrated along with a generative pre-trained transformer (not shown), deep learning models or large language model may use a large dataset so training is suspended until power from a renewable energy sources is above a predetermined threshold. In other words, training may be suspended (instead of migrating) depending on ML model attributes (e.g., training constraints).

ML is the focus of many enterprises with enterprises generating custom ML models to solve their specific issues. At the same time, there is strong push towards sustainable development across enterprises. The techniques presented herein help enterprises to train ML models in a more sustainable way, minimizing or reducing the carbon footprint and help with coordinated distribution of ML models.

The techniques presented herein generated and execute a deployment plan for a coordinated distribution of ML models for training across distributed computing resource groups (datacenters) based on attributes of the models (including checkpointing), hardware and time constraints, and availability of renewable energy sources at the distributed resource groups. The deployment plan is generated using a non-dominated sorting genetic algorithm that evaluates various combinations of training ML models at various datacenters to maximize use of renewable energy while meeting training constraints (training time deadlines) and/or model performance constraints. The deployment plan includes migration of ML models from one computing resource group to another computing resource group to increase use of power from renewable energy sources.

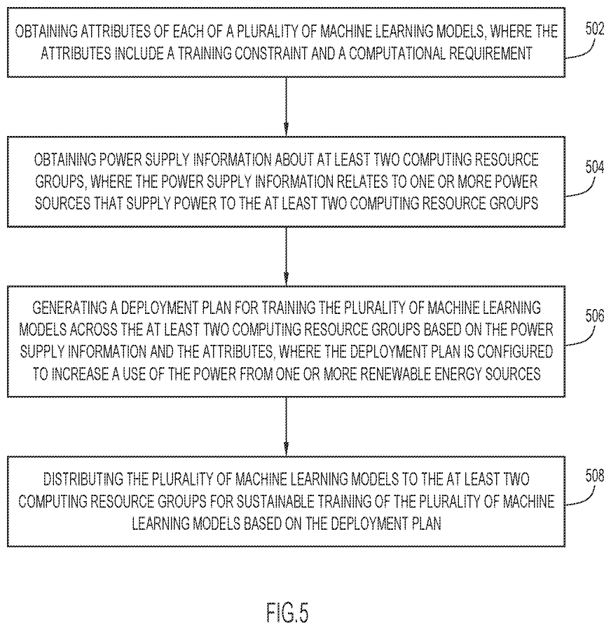

FIG. 5 is a flowchart illustrating a computer-implemented method 500 of distributing machine learning models to computing resource groups for sustainable training based on the deployment plan, according to an example embodiment. The computer-implemented method 500 may be performed by a computing device such as a server or a group of servers or an apparatus of FIG. 6, e.g., the scheduler 310 of FIG. 3 and/or the orchestration service 410 of FIG. 4.

The computer-implemented method 500 involves, at 502, obtaining attributes of each of a plurality of machine learning models. The attributes include a training constraint and a computational requirement.

The computer-implemented method 500 further involves, at 504, obtaining power supply information about at least two computing resource groups. The power supply information relates to one or more power sources that supply power to the at least two computing resource groups.

The computer-implemented method 500 further involves at 506, generating a deployment plan for training the plurality of machine learning models across the at least two computing resource groups based on the power supply information and the attributes. The deployment plan is configured to increase a use of the power from one or more renewable energy sources

The computer-implemented method 500 further involves at 508, distributing the plurality of machine learning models to the at least two computing resource groups for sustainable training of the plurality of machine learning models based on the deployment plan.

According to one or more example embodiments, the operation 508 of distributing the plurality of machine learning models to the at least two computing resource groups may include migrating, at a checkpoint during training, one or more of the plurality of machine learning models from a current computing resource group to a different one of the at least two computing resource groups, based on the deployment plan.

In one instance, the plurality of machine learning models may include at least two of: a neural network, a generative pre-trained transformer (GPT) model, a deep learning model, or a large language model (LLM). The computer-implemented method 500 may further involve obtaining the training constraint and the computational requirement of a new machine learning model. The training constraint may include checkpointing characteristics and the computational requirement may include a hardware resources requirement to train the new machine learning model within a specified deadline. The computer-implemented method 500 may further involve generating, by applying a multi-objective genetic algorithm, a new deployment plan to include training of the new machine learning model based on the attributes and the training constraint and the computational requirement of the new machine learning model.

In one form, in the computer-implemented method 500, the at least two computing resource groups may be a plurality of geographically remote enterprise sites of a distributed data center. Each of the plurality of geographically remote enterprise sites may include at least one of a plurality of graphics processing units or a plurality of tensor processing units. Alternatively, the at least two computing resource groups may be a plurality of data centers that host network and computing equipment for performing hosting and computing functions.

According to one or more example embodiments, the computer-implemented method 500 may further involve obtaining hardware resource information for each of the at least two computing resource groups. The deployment plan may be generated further based on the hardware resource information.

In another form, the operation 502 of obtaining the attributes of each of the plurality of machine learning models may include obtaining a model profile for each of the plurality of artificial intelligence or machine learning models. The model profile may include a unique identifier assigned to a respective learning model and at least two of: one or more hardware resources for training the respective learning model within a specified timeframe, a memory size for storing a plurality of parameters for training the respective learning model, a network bandwidth for distributing training data of the respective learning model to the one or more hardware resources, a power consumption profile for training the respective learning model, and a checkpointing type of the respective learning model.

In yet another form, the operation 504 of obtaining the power supply information about the at least two computing resource groups may include obtaining time-series data about the one or more power sources that supply the power to a respective computing resource group of the at least two computing resource groups. The operation 504 of obtaining the power supply information about the at least two computing resource groups may further include generating a time-series energy baseline for the respective computing resource group. The time-series energy baseline may indicate a first portion of the power supplied by the one or more renewable energy sources and a second portion of the power supplied by one or more non-renewable energy sources of a total power supplied to the respective computing resource group at a particular point in time. The deployment plan may include instructions for migrating one of the plurality of artificial intelligence or machine learning models to a different computing resource group based on the time-series energy baseline of a current computing resource group indicating that the first portion is below a predetermined threshold.

In one instance, the operation 506 of generating the deployment plan may include generating instructions for migrating a first learning model and a second learning model among the plurality of machine learning models from a current computing resource group to one or more different computing resource groups at a respective checkpoint based on determining that the one or more different computing resource groups have more available power from the one or more renewable energy sources than the current computing resource group.

In another instance, the operation 506 of generating the deployment plan may include determining a checkpointing type of each of the plurality of artificial intelligence or machine learning models based on the attributes and obtaining a plurality of objectives for the deployment plan. The plurality of objectives may include increasing the use of the power from the one or more renewable energy sources and decreasing total training time of the plurality of artificial intelligence or machine learning models. The operation 506 of generating the deployment plan may further include determining a target computing resource group from the at least two computing resource groups to train each of the plurality of artificial intelligence or machine learning models in an interval between two adjacent checkpoints specific to a respective learning model, based on the checkpointing type and the plurality of objectives.

In yet another instance, the operation 506 of generating the deployment plan may further include transferring, at a checkpoint, from a first storage associated with a current computing resource group to a second storage associated with a different computing resource group, a result data set that includes a state of the respective learning model and instructing the different computing resource group to continue training the respective learning model using the result data set.

According to one or more example embodiments, the checkpoint may occur after a predetermined number of iterations in training the respective learning model.

FIG. 6 is a hardware block diagram of a computing device 600 that may perform functions associated with any combination of operations in connection with the techniques depicted in FIGS. 1-5, according to various example embodiments, including, but not limited to, operations of the computing device such as an apparatus, or one or more servers that execute of FIG. 1, the sustainability service 220 of FIGS. 2-4, the scheduler 310 of FIGS. 3 and 4, the orchestration service 410 of FIG. 4, the first training service 422a of FIG. 4, the second training service 422b of FIG. 4, the first checkpoint manager 424a of FIG. 4, the second checkpoint manager 424b, and/or one of its components. Further, the computing device 600 may be representative of one of network devices, network and computing equipment, a hardware of an enterprise, or an apparatus. It should be appreciated that FIG. 6 provides only an illustration of one example embodiment and does not imply any limitations with respect to the environments in which different example embodiments may be implemented. Many modifications to the depicted environment may be made.

In at least one embodiment, computing device 600 (e.g., an apparatus) may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with one or more memory elements 604 (or vice versa), or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, and/or any other I/O port(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a display 616 such as a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to enable network communications, and a processor. The processor is configured to perform a method that involves obtaining attributes of each of a plurality of machine learning models. The attributes include a training constraint and a computational requirement. The method further involves obtaining power supply information about at least two computing resource groups. The power supply information relates to one or more power sources that supply power to the at least two computing resource groups. The method further involves generating a deployment plan for training the plurality of machine learning models across the at least two computing resource groups based on the power supply information and the attributes. The deployment plan is configured to increase a use of the power from one or more renewable energy sources. The method further involves distributing the plurality of machine learning models to the at least two computing resource groups for sustainable training of the plurality of machine learning models based on the deployment plan.

In yet another example embodiment, one or more non-transitory computer readable storage media encoded with instructions are provided. When the media is executed by a processor, the instructions cause the processor to execute a method that includes obtaining attributes of each of a plurality of machine learning models. The attributes include a training constraint and a computational requirement. The method further includes obtaining power supply information about at least two computing resource groups. The power supply information relates to one or more power sources that supply power to the at least two computing resource groups. The method further includes generating a deployment plan for training the plurality of machine learning models across the at least two computing resource groups based on the power supply information and the attributes. The deployment plan is configured to increase a use of the power from one or more renewable energy sources. The method further includes distributing the plurality of machine learning models to the at least two computing resource groups for sustainable training of the plurality of machine learning models based on the deployment plan.

In yet another example embodiment, a system is provided that includes the devices and operations explained above with reference to FIGS. 1-6.

The programs described herein (e.g., control logic 620) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable time frame. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 606 and/or memory elements(s) 604 can store data, software, code, instructions (e.g., processor instructions), logic, parameters, combinations thereof, and/or the like used for operations described herein. This includes the storage 606 and/or memory elements(s) 604 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining attributes of each of a plurality of machine learning models, wherein the attributes include a training constraint and a computational requirement;
obtaining power supply information about at least two computing resource groups, wherein the power supply information relates to one or more power sources that supply power to the at least two computing resource groups;
generating a deployment plan for training the plurality of machine learning models across the at least two computing resource groups based on the power supply information and the attributes, wherein the deployment plan is configured to increase a use of the power from one or more renewable energy sources; and
distributing the plurality of machine learning models to the at least two computing resource groups for sustainable training of the plurality of machine learning models based on the deployment plan.

2. The computer-implemented method of claim 1, wherein distributing the plurality of machine learning models to the at least two computing resource groups includes:
migrating, at a checkpoint during training, one or more of the plurality of machine learning models from a current computing resource group to a different one of the at least two computing resource groups, based on the deployment plan.

3. The computer-implemented method of claim 1, wherein the plurality of machine learning models include at least two of: a neural network, a generative pre-trained transformer (GPT) model, a deep learning model, or a large language model (LLM) and further comprising:
obtaining the training constraint and the computational requirement of a new machine learning model, the training constraint including checkpointing characteristics and the computational requirement including a hardware resources requirement to train the new machine learning model within a specified deadline; and
generating, by applying a multi-objective genetic algorithm, a new deployment plan to include training of the new machine learning model based on the attributes and the training constraint and the computational requirement of the new machine learning model.

4. The computer-implemented method of claim 1, wherein the at least two computing resource groups are one of:
a plurality of geographically remote enterprise sites of a distributed data center, each of the plurality of geographically remote enterprise sites including at least one of a plurality of graphics processing units or a plurality of tensor processing units, or
a plurality of data centers that host network and computing equipment for performing hosting and computing functions.

5. The computer-implemented method of claim 4, further comprising:
obtaining hardware resource information for each of the at least two computing resource groups, wherein the deployment plan is generated further based on the hardware resource information.

6. The computer-implemented method of claim 1, wherein obtaining the attributes of each of the plurality of machine learning models includes:
obtaining a model profile for each of the plurality of machine learning models, wherein the model profile includes a unique identifier assigned to a respective learning model and at least two of:
one or more hardware resources for training the respective learning model within a specified timeframe,
a memory size for storing a plurality of parameters for training the respective learning model,
a network bandwidth for distributing training data of the respective learning model to the one or more hardware resources,
a power consumption profile for training the respective learning model, and
a checkpointing type of the respective learning model.

7. The computer-implemented method of claim 1, wherein obtaining the power supply information about the at least two computing resource groups includes:
obtaining time-series data about the one or more power sources that supply the power to a respective computing resource group of the at least two computing resource groups; and
generating a time-series energy baseline for the respective computing resource group, wherein the time-series energy baseline indicates a first portion of the power supplied by the one or more renewable energy sources and a second portion of the power supplied by one or more non-renewable energy sources of a total power supplied to the respective computing resource group at a particular point in time,
wherein the deployment plan includes instructions for migrating one of the plurality of machine learning models to a different computing resource group based on the time-series energy baseline of a current computing resource group indicating that the first portion is below a predetermined threshold.

8. The computer-implemented method of claim 1, wherein generating the deployment plan includes:
generating instructions for migrating a first learning model and a second learning model among the plurality of machine learning models from a current computing resource group to one or more different computing resource groups at a respective checkpoint based on determining that the one or more different computing resource groups have more available power from the one or more renewable energy sources than the current computing resource group.

9. The computer-implemented method of claim 1, wherein generating the deployment plan includes:
determining a checkpointing type of each of the plurality of machine learning models based on the attributes;
obtaining a plurality of objectives for the deployment plan, the plurality of objectives include increasing the use of the power from the one or more renewable energy sources and decreasing total training time of the plurality of machine learning models; and
determining a target computing resource group from the at least two computing resource groups to train each of the plurality of machine learning models in an interval between two adjacent checkpoints specific to a respective learning model, based on the checkpointing type and the plurality of objectives.

10. The computer-implemented method of claim 9, wherein generating the deployment plan includes:
transferring, at a checkpoint, from a first storage associated with a current computing resource group to a second storage associated with a different computing resource group, a result data set that includes a state of the respective learning model; and
instructing the different computing resource group to continue training the respective learning model using the result data set.

11. The computer-implemented method of claim 10, wherein the checkpoint occurs after a predetermined number of iterations in training the respective learning model.

12. An apparatus comprising:
a memory;
a network interface configured to enable network communications; and
a processor, wherein the processor is configured to perform a method comprising:
obtaining attributes of each of a plurality of machine learning models, wherein the attributes include a training constraint and a computational requirement;
obtaining power supply information about at least two computing resource groups, wherein the power supply information relates to one or more power sources that supply power to the at least two computing resource groups;
generating a deployment plan for training the plurality of machine learning models across the at least two computing resource groups based on the power supply information and the attributes, wherein the deployment plan is configured to increase a use of the power from one or more renewable energy sources; and
distributing the plurality of machine learning models to the at least two computing resource groups for sustainable training of the plurality of machine learning models based on the deployment plan.

13. The apparatus of claim 12, wherein the processor is configured to distribute the plurality of machine learning models to the at least two computing resource groups by:
migrating, at a checkpoint during training, one or more of the plurality of machine learning models from a current computing resource group to a different one of the at least two computing resource groups, based on the deployment plan.

14. The apparatus of claim 12, wherein the plurality of machine learning models include at least two of: a neural network, a generative pre-trained transformer (GPT) model, a deep learning model, or a large language model (LLM) and the processor is further configured to perform:
obtaining the training constraint and the computational requirement of a new machine learning model, the training constraint including checkpointing characteristics and the computational requirement including a hardware resources requirement to train the new machine learning model within a specified deadline; and
generating, by applying a multi-objective genetic algorithm, a new deployment plan to include training of the new machine learning model based on the attributes and the training constraint and the computational requirement of the new machine learning model.

15. The apparatus of claim 12, wherein the at least two computing resource groups are a plurality of geographically remote enterprise sites of a distributed data center, each of the plurality of geographically remote enterprise sites including at least one of a plurality of graphics processing units or a plurality of tensor processing units for training one or more learning models.

16. The apparatus of claim 12, wherein the at least two computing resource groups are one of:
a plurality of geographically remote enterprise sites of a distributed data center, each of the plurality of geographically remote enterprise sites including at least one of a plurality of graphics processing units or a plurality of tensor processing units, or
a plurality of data centers that host network and computing equipment for performing hosting and computing functions.

17. The apparatus of claim 16, wherein the processor is configured to perform:
obtaining hardware resource information for each of the at least two computing resource groups, wherein the deployment plan is generated further based on the hardware resource information.

18. One or more non-transitory computer readable storage media encoded with software comprising computer executable instructions that, when executed by a processor, cause the processor to perform a method including:
obtaining attributes of each of a plurality of machine learning models, wherein the attributes include a training constraint and a computational requirement;
obtaining power supply information about at least two computing resource groups, wherein the power supply information relates to one or more power sources that supply power to the at least two computing resource groups;
generating a deployment plan for training the plurality of machine learning models across the at least two computing resource groups based on the power supply information and the attributes, wherein the deployment plan is configured to increase a use of the power from one or more renewable energy sources; and
distributing the plurality of machine learning models to the at least two computing resource groups for sustainable training of the plurality of machine learning models based on the deployment plan.

19. The one or more non-transitory computer readable storage media according to claim 18, wherein distributing the plurality of machine learning models to the at least two computing resource groups includes:
migrating, at a checkpoint during training, one or more of the plurality of machine learning models from a current computing resource group to a different one of the at least two computing resource groups, based on the deployment plan.

20. The one or more non-transitory computer readable storage media according to claim 18, wherein the plurality of machine learning models include at least two of: a neural network, a generative pre-trained transformer (GPT) model, a deep learning model, or a large language model (LLM) and the method further comprising:
obtaining the training constraint and the computational requirement of a new machine learning model, the training constraint including checkpointing characteristics and the computational requirement including a hardware resources requirement to train the new machine learning model within a specified deadline; and
generating, by applying a multi-objective genetic algorithm, a new deployment plan to include training of the new machine learning model based on the attributes and the training constraint and the computational requirement of the new machine learning model.
